(19) United States
(12) Patent Application Publication
(10) Pub. No.: US 2015/0282034 A1
(43) Pub. Date: Oct. 1, 2015

(54) RESELECTION

(71) Applicant: RENESAS MOBILE CORPORATION, Tokyo (JP)

(72) Inventors: Brian Martin, Farnham (GB); Keiichi Kubota, Weybridge (GB); Christopher Callender, Cleish (GB)

(21) Appl. No.: 14/435,079

(22) PCT Filed: Oct. 9, 2013
(86) PCT No.: PCT/IB2013/059242

§ 371 Date: Apr. 10, 2015

(30) Foreign Application Priority Data
Oct. 10, 2012 (GB) 1218203.6

(51) Int. Cl. H04W 36/30; H04W 36/08

(52) U.S. Cl. CPC H04W 36/30; H04W 36/08

(57) ABSTRACT

Measures for use in cell reselection in a cellular telecommunications network. A user equipment calculates a first cell ranking criterion for a serving cell of said user equipment and a second cell ranking criterion for at least one neighbour cell of said user equipment. Calculating at least one of the first cell ranking criterion for the serving cell and the second cell ranking criterion for the at least one neighbour cell comprises combining a measure of downlink-based coverage and a measure of uplink-based coverage for a respective cell. The user equipment performs cell reselection evaluation at least on the basis of the calculated first cell ranking criterion and the calculated second cell ranking criterion.

### TECHNICAL FIELD

The present invention relates to reselection. In particular, but not exclusively, the present invention relates to measures, including methods, apparatus and computer program products for use in cell reselection in a cellular telecommunications network.

### BACKGROUND

Heterogeneous deployments, in which low power nodes (for example pico cells) are employed within macro cells are becoming increasingly important to cellular network operators as a means of enhancing system performance (for example in terms of coverage and capacity).

In 3rd generation partnership project (3GPP) work item (WI) R1-110687, co-channel heterogeneous network deployment in which low power nodes use the same carrier frequency as the macro-cell is presented for study of high speed packet access (HSPA)/long term evolution (LTE) in 3GPP. Under co-channel deployment, introduction of the low power nodes to the macro-cell brings challenges in terms of the uplink (UL) control channel reliability as well as the interference management between low and high power nodes.

Problems arise from heterogeneous network deployment when small power nodes are placed in the high power macro-cell layout and are mainly caused by the UL imbalance caused by the transmit power difference between low power nodes and the macro cell. Simulation results have been used (see for example 3GPP WI R1-110687) to illustrate three potential problems; firstly, unreliable high speed dedicated physical control channel (HS-DPCCH) decoding at the serving cell, secondly, excessive UL interference from the macro-cell to the low power nodes, and thirdly excessive UL interference from the low power nodes to the macro cell.

It would therefore be desirable to provide improved measures for tackling UL control channel reliability and/or interference management issues in cellular telecommunications networks, including in co-channel heterogeneous networks.

### SUMMARY

In accordance with a first aspect of the present invention, there is provided apparatus for use in cell reselection in a cellular telecommunications network, the apparatus comprising a processing system adapted to, at a user equipment:

calculate a first cell ranking criterion for a serving cell of the user equipment;

calculate a second cell ranking criterion for at least one neighbour cell of the user equipment, wherein calculating at least one of the first cell ranking criterion for the serving cell and the second cell ranking criterion for the at least one neighbour cell comprises combining a measure of downlink-based coverage and a measure of uplink-based coverage for a respective cell; and

perform cell reselection evaluation at least on the basis of the calculated first cell ranking criterion and the calculated second cell ranking criterion.

In embodiments, the user equipment comprises a mobile terminal.

In embodiments, the apparatus comprises one or more of a chipset, an RF front end module, and an RF transceiver.

In accordance with a second aspect of the present invention, there is provided a method for use in cell reselection in a cellular telecommunications network, the method comprising, at a user equipment:

calculating a first cell ranking criterion for a serving cell of the user equipment;

calculating a second cell ranking criterion for at least one neighbour cell of the user equipment, wherein calculating at least one of the first cell ranking criterion for the serving cell and the second cell ranking criterion for the at least one neighbour cell comprises combining a measure of downlink-based coverage and a measure of uplink-based coverage for a respective cell; and

performing cell reselection evaluation at least on the basis of the calculated first cell ranking criterion and the calculated second cell ranking criterion.

In accordance with a third aspect of the present invention, there is provided a computer program product comprising a set of instructions, which, when executed by a computerised device, cause the computerised device to perform the method of the second aspect of the present invention.

In accordance with a fourth aspect of the present invention, there is provided apparatus for use in cell reselection in a cellular telecommunications network, the apparatus comprising a processing system adapted to, at a network entity:

calculate one or more modified cell reselection parameters of at least one of a first cell ranking criterion for a serving cell of a user equipment and a second cell ranking criterion for at least one neighbour cell of the user equipment, the calculation of the one or more modified cell reselection parameters being carried out at least on the basis of a measure of uplink-based coverage for a respective cell; and

causing transmittal of the one or modified more cell reselection parameters to the user equipment.

In embodiments, the network entity comprises a radio network controller (RNC) and/or a base station.

In embodiments, the apparatus comprises one or more of a chipset and an RF transceiver.

In embodiments, the network entity comprises an evolved Node B (eNB) and the cellular telecommunications network comprises an evolved universal mobile telecommunications system radio access network (EUTRAN).

In embodiments, the apparatus of the first and/or fourth aspects of the present invention is configured for use in a long term evolution (LTE) system, long term evolution advanced (LTE-A) system and/or a wideband code division multiple access (WCDMA) system.

In accordance with a fifth aspect of the present invention, there is provided a method for use in cell reselection in a cellular telecommunications network, the method comprising, at a network entity:

calculating one or more modified cell reselection parameters of at least one of a first cell ranking criterion for a serving cell of a user equipment and a second cell ranking criterion for at least one neighbour cell of the user equipment, the calculation of the one or more modified cell reselection parameters being carried out at least on the basis of a measure of uplink-based coverage for a respective cell; and

causing transmittal of the one or modified more cell reselection parameters to the user equipment.

In accordance with a sixth aspect of the present invention, there is provided a computer program product comprising a set of instructions, which, when executed by a computerised device, cause the computerised device to perform the method of the fifth aspect of the present invention.

Embodiments comprises a computer program product comprising a non-transitory computer-readable storage medium having computer readable instructions stored thereon, the computer readable instructions being executable by a computerized device to cause the computerized device to perform the method of the second or fifth aspects of the present invention.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a simplified block diagram of a communication network within which embodiments operate;

FIG. 2 shows a flow diagram according to embodiments;

FIG. 3 shows a flow diagram according to embodiments; and

FIG. 4 is a simplified block diagram of various network devices, which are example electronic devices suitable for use in practicing embodiments.

### DETAILED DESCRIPTION

In the following, examples and embodiments of the present invention are described with reference to the drawings. For illustrating the present invention, the examples and embodiments will be described in connection with a cellular communication network based on a 3GPP-type cellular system, such as universal mobile telecommunication system (UMTS). However, it is to be noted that the present invention is not limited to an application using such types of communication system, but is also applicable in other types of communication systems such as EUTRAN and the like.

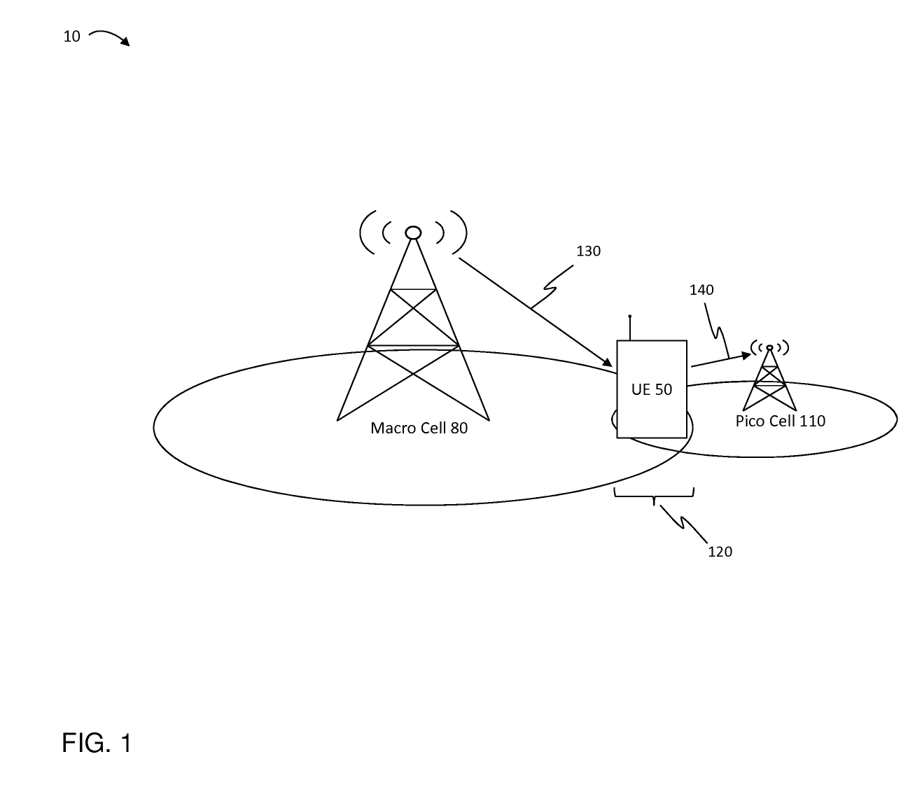

A basic system architecture of a communication network where examples of embodiments are practised may comprise a commonly known architecture of one or more communication networks comprising a wired or wireless access network subsystem and a core network. A cellular telecommunications network 10 according to embodiments will now be described with reference to FIG. 1. In these embodiments, cellular telecommunication network 10 comprises a serving cell 80 that is currently serving a UE 50, one or more neighbouring cells that are neighbours of the serving cell 80 and a radio network controller (RNC) (not shown). Serving cell 80 comprises a base station for serving user equipment within its radio coverage area and in this example comprises a macro cell. The one or more neighbouring cells 110 also comprise base stations for serving user equipment within their radio coverage area and in this example comprises a pico cell 110, but could equally comprise multiple pico cells and/or one or more micro or femto cells or another macro cell.

In this example, cellular telecommunications network 10 comprises a heterogeneous network in which serving call 80 comprises a relatively high power node and the neighbour cell 110 comprises a relatively low power node with uplink and/or downlink coverage at least partially overlapping with the macro cell. In these embodiments, serving cell 80 comprises a macro cell 80 and neighbour cell 110 comprises a pico cell 110.

User equipment 50 or another wireless transmit/receive device having a similar function, such as a modem chipset, a chip, a module etc., which can also be part of a user equipment or attached as a separate element to a user equipment, or the like, is able to communicate with the serving cell 80 or neighbour cell 110 via one or more wireless (or ‘radio’) communication channels for transmitting several types of data.

Cellular telecommunications network 10 may additionally be in communication with various mobility management entities (MMEs) (not shown), which facilitate mobility of user equipments across various carriers, and/or network management entities, which manage resources of the communication network 10, for example a radio network controller.

The general functions and interconnections of the described elements, which also depend on the actual network type, are known to those skilled in the art and described in corresponding specifications, so that a detailed description thereof is omitted herein. However, it is to be noted that several additional network elements and signalling links may be employed for a communication connection to or from user equipments, cells, RNCs serving gateways (S-GWs), packet data network gateways (P-GWs), besides those described in detail herein below.

In the scenario depicted in FIG. 1, in known systems, only the downlink (DL) coverage is taken into account by UE 50 when performing cell reselection evaluation. Wireless link 130 denotes a strongest downlink (DL) from macro cell 80 to UE 50. Wireless link 140 denotes a strongest downlink (UL) from UE 50 to pico cell 110. When UE 50 is in the “imbalance zone” as shown by item 120 in FIG. 1, then the UE may be relatively far from macro cell 80, but relatively close to pico cell 110. Due to the much smaller output power of pico cell 110, UE 50 may find macro cell 80 to be the best ranked cell, based on the measured DL power. However, due to UE 50 being relatively far from macro cell 80, UE 50 needs to use a high UL power to communicate with that cell, which causes excessive interference to the nearby pico cell 110. In embodiments, in order to avoid interfering with the pico cell 110, UE 50 should attempt to camp on pico cell 110 if the DL is still of reasonable quality even if it is not the best cell according to known reselection calculations.

Note that the term ‘camp’ is used herein to refer to a situation when a UE is in idle mode and has completed the cell selection/reselection process and has chosen a cell.

Known cell reselection procedures are defined in 3GPP technical specification (TS) 25.304 subclause 5.2.6.1.4 as follows:

For the case when absolute priority reselection is not used:

Rₛ=Q_{meas,s}+Qhystₛ+Qoffmbms

Rₙ=Q_{meas,n}−Qoffset_{s,n}+Qoffmbms−TOₙ*(1−Lₙ)

where:
the signalled value Qoffmbms is only applied to those cells (serving or neighbouring) belonging to the multimedia broadcast-multicast service preferred layer (MBMS PL)
for a closed subscriber group (CSG) cell not included in the neighbour cell list, then Qoffset_{s,n} and Qoffmbms have the value 0.
   where:

TOₙ=TEMP_OFFSETₙ*W(PENALTY_TIMEₙ−Tₙ)

Lₙ=0 if HCS_PRIOₙ=HCS_PRIOₛ

Lₙ=1 if HCS_PRIOₙ< >HCS_PRIOₛ

W(x)=0 for x<0

W(x)=1 for x>=0

TEMP_OFFSETₙ applies an offset to the H and R criteria for the duration of PENALTY_TIMEₙ after a timer Tₙ has started for that neighbouring cell. TEMP_OFFSETₙ and PENALTY_TIMEₙ are only applicable if the usage of HCS is indicated in system information.
For the case when absolute priority reselection is used:
The following definitions apply for the layers for which Thresh_{x,high2} or Thresh_{x,low2} are not provided:
Criterion 1: the Srxlev_{nonServingCell,x} of a cell on an evaluated higher absolute priority layer is greater than Thresh_{x,high} during a time interval Treselection;
Criterion 2: (Srxlev_{ServingCell}<Thresh_{serving,low} or Squal_{servingCell}<=0) and the Srxlev_{nonservingcCell,x} of a inter-frequency cell on an evaluated equal absolute priority layer is greater than Thresh_{x,low} during a time interval Treselection;
Criterion 3: (Srxlev_{ServingCell}<Thresh_{serving,low} or Squal_{servingCell}<=0) and the Srxlev_{nonservingcCell,x} of a cell on an evaluated lower absolute priority layer is greater than Thresh_{x,low} during a time interval Treselection;
   The following definitions apply for the layers for which both Thresh_{x,high2} and Thresh_{x,low2} are provided:
Criterion 4: the Squal_{nonservingcCell,x} of a cell on an evaluated higher absolute priority layer is greater than Thresh_{x,high2} during a time interval Treselection;
Criterion 5: (Squal_{servingCell}<Thresh_{serving,low2} or Srxlev_{ServingCell}<=0) and the Squal_{nonservingCell,x} of a cell on an evaluated lower absolute priority layer is greater than Thresh_{x,low2} during a time interval Treselection;

In embodiments, uplink coverage is also taken into account in cell reselection evaluation (idle mode mobility). Embodiments involve incorporation of a measure of uplink-based coverage, such as an estimate of an UE uplink signal received at the base station. Embodiments involve comparison of the uplink signals between potential neighbour cells in order to determine which cell to camp on, whilst also taking into account downlink-based coverage (as per existing cell reselection evaluation, for example as laid out in subclause 5.2.6.1.4 of TS 25.304 above).

Embodiments comprise calculation of one or more modified cell reselection parameters which take UL-based coverage into account; cell reselection evaluation is then carried out on the basis of the modified cell reselection parameters.

In first embodiments, a UE-based approach is employed. In these embodiments, the UE obtains a measure of uplink-based coverage, for example in the form of pathloss information for the currently camped cell and/or one or more detected neighbour cells, uses the measure of uplink-based coverage to calculate modified cell reselection parameters and performs cell reselection evaluation on the basis of the modified cell reselection parameters.

Embodiments comprise, measures, including methods, apparatus, and computer program products for use in cell reselection in a cellular telecommunications network. UE 50 calculates a first cell ranking criterion for a serving cell of the user equipment and a second cell ranking criterion for at least one neighbour cell of the user equipment. Calculation of at least one of the first cell ranking criterion for the serving cell and the second cell ranking criterion for the at least one neighbour cell comprises combining a measure of downlink-based coverage and a measure of uplink-based coverage for a respective cell. UE 50 performs cell reselection evaluation at least on the basis of the calculated first cell ranking criterion and the calculated second cell ranking criterion.

In embodiments, the combining comprises adding the measure of downlink-based coverage to the measure of uplink-based coverage.

In embodiments, the combining comprises controlling the extent to which the measure of uplink-based coverage for a respective cell affects the cell reselection evaluation. The controlling may comprise multiplying the measure of uplink-based coverage for a respective cell by a weighting factor (herein denoted weighting factor ‘X’) to produce a first product and the combining comprises adding the first product to the measure of downlink-based coverage. The controlling may comprise multiplying the measure of uplink-based coverage for a respective cell by a weighting factor to produce a first product and multiplying the measure of downlink-based coverage for a respective cell by the weighting factor subtracted from 1 to produce a second product and the combining comprises adding the first product to the second product. The weighting factor may for example comprise a value between zero and 1.

In embodiments, the measure of uplink-based coverage comprises a pathloss metric for a respective cell. In embodiments, UE 50 receives the path loss metric for one or more of the serving cell and the at least one neighbour cell from the serving cell.

According to embodiments, UE 50 reads system information from the at least one neighbour cell, such system information comprising the power of a pilot channel signal transmitted by the at least one neighbour cell. UE 50 measures a power of at least one signal received from the at least one neighbour cell, and calculates the path loss metric for the at least one neighbour cell on the basis of the pilot channel signal power and the measured power.

Each cell broadcasts a downlink pilot channel signal, such as a common pilot channel (CPICH) Tx power in system information. In embodiments, UE 50 calculates from this information the pathloss for a cell according to:

Pathloss=CPICH Tx Power(as broadcast by cell)−CPICH received (measured) power

According to embodiments, UE 50 measures a power of at least one signal received from the at least one neighbour cell, and calculates the path loss metric for the at least one neighbour cell on the basis of the measured power and a default value for a neighbour cell pilot channel signal power.

Embodiments update the ranking calculation for cell reselection evaluation taking into account the calculate pathloss (PL,s denotes the pathloss for the serving cell; PL,n denotes the pathloss for a neighbour cell) multiplied by a new weighting factor X, for example according to one, the other or both of the following equations:

Rₛ=Q_{meas,s}+Qhystₛ+Qoffmbms−X*PL,s

Rₙ=Q_{meas,n}−Qoffset_{s,n}+Qoffmbms−TOₙ*(1−Lₙ)−X*PL,n

Where Rs denotes a cell ranking criterion for a serving cell and Rn denotes a cell ranking criterion for a neighbour cell and PL,s is the pathloss of the serving cell, PL,n is the pathloss of a neighbour cell N. The remaining terms (DL-related terms) of these equations are as per subclause 5.2.6.1.4 of TS 25.304 laid out above. A cell ranking criterion may be calculated for multiple neighbour cells.

Note that the above equations involve introducing a measure of UL-based coverage into both the cell ranking criterion for the serving cell and the cell ranking criterion for a neighbour cell according to embodiments. However, according to other embodiments, a measure of UL-based coverage may only be introduced into the cell ranking criterion for one or the other of the serving cell and a neighbour cell.

Similarly, in the equations above, weighting factor X is indicated as being applied to both the cell ranking criterion for the serving cell and the cell ranking criterion for a neighbour cell according to embodiments, but according to other embodiments, weighting factor X is only applied to one or the other of the cell ranking criterion for the serving cell and the cell ranking criterion for a neighbour cell.

In embodiments, the weighting factor X is applied such that the effect of the downlink measurements becomes less as the weighting factor X moves towards 1, for example according to one or more of the following cell ranking criterion equations:

Rₛ=(1−X)Q_{meas,s}+Qhystₛ+Qoffmbms−X*PL,s

Rₙ=(1−X)Q_{meas,n}−Qoffset_{s,n}+Qoffmbms−TOₙ*(1−Lₙ)−X*PL,n

In embodiments, weighting factor X is determined by the network. In embodiments, weighting factor X is received by UE 50 from the serving cell. In embodiments, weighting factor X is received by UE 50 from the at least one neighbour cell.

Embodiments comprise UE 50 reading system information from the at least one neighbour cell and adjusting the received weighting factor on the basis of the system information read from the at least one neighbour cell.

Embodiments comprise UE 50 reading system information from one or more of the serving cell and the at least one neighbour cell. In such embodiments the performed cell reselection evaluation is carried out further on the basis of the system information read from one or more of the serving cell and the at least one neighbour cell.

Embodiments comprise UE 50 receiving from one or more of the serving cell and the at least one neighbour cell an indication of measured uplink interference for a respective cell. In such embodiments, the performed cell reselection evaluation is carried out by UE 50 further on the basis of the received indication.

In embodiments, UE 50 calculates the first cell ranking criterion for the serving cell by combining a measure of downlink-based coverage and a measure of uplink-based coverage for the serving cell and UE 50 calculates the second cell ranking criterion for the at least one neighbour cell by combining a measure of downlink-based coverage and a measure of uplink-based coverage for the at least one neighbour cell.

In embodiments, UE 50 triggers cell reselection to the at least one neighbour cell if the performed cell reselection evaluation indicates that the at least one neighbour cell ranks higher than the serving cell.

In embodiments, the cellular telecommunications network comprises a heterogeneous network in which one of the serving call and the at least one neighbour cell comprises a relatively high power node and another of the serving call and the at least one neighbour cell comprises a relatively low power node with uplink and/or downlink coverage at least partially overlapping with the macro cell. The relatively high power node may for example comprise a macro cell and the relatively low power node may for example comprise a micro, pico or femto cell. In embodiments, the relatively high power node uses at least one carrier frequency which is the same as at least one carrier frequency of the relatively low power node.

In embodiments, the measure of downlink-based coverage for the serving cell is calculated on the basis of one or more of:

a quality value of one or more signals received by the user equipment from the serving cell (i.e. Q_{meas,s}),

a hysteresis value (i.e. Qhystₛ), and

a first offset value in the case of the serving cell belonging to a multimedia broadcast and multicast service preferred layer (MBMS PL) (i.e. Qoffmbms for Rs equation).

In embodiments, the measure of downlink-based coverage for the at least one neighbour cell is calculated on the basis of one or more of:

a quality value of one or more signals received by the user equipment from the at least one neighbour cell (i.e. Q_{meas,n}),

a second offset value calculated relative to the serving cell (i.e. Qoffset_{s,n}),

a third offset value in the case of the at least one neighbour cell belonging to a multimedia broadcast-multicast service preferred layer (MBMS PL) (i.e. Qoffmbms for Rn equation), and

and a temporal offset in the case of a hierarchical cell structure (HCS) being indicated in system information for the at least one neighbour cell (i.e. TOₙ*(1−Lₙ) from Rn equation).

In embodiments, UE 50 applies a threshold for the current cell and/or neighbour cell measurement before reading and applying the UL coverage information (for example if Q_{meas,s}<threshold1 AND Qmeas,n>threshold2, then read neighbour cell information and start using the modified reselection calculation.

In embodiments, UE 50 only calculates the second cell ranking criterion for the at least one neighbour cell of the user equipment and performs the cell reselection evaluation if one or more predetermined threshold criteria are met. In embodiments, one of the one or more predetermined threshold criteria comprises a quality value of one or more signals received by the user equipment from the serving cell being less than a first predetermined threshold. In embodiments, one of the one or more predetermined threshold criteria comprises a quality value of one or more signals received by the user equipment from the at least one neighbour cell being greater than a second predetermined threshold.

In embodiments, weighting factor X is broadcast by the NW to multiple UEs, for example by serving cell and/or one or more neighbour cells. The weighting factor acts to adjust the weight (or ‘the effect’) that the uplink-based coverage has on the cell reselection calculation.

Other additional parameters may be involved in the calculation of cell ranking criteria and the cell reselection evaluation process. For example, a cell typically broadcasts its own level of measured uplink interference. The UE may obtain this information by reading the neighbour cell system information and take this into account in the cell reselection evaluation process.

Embodiments can be employed for co-ordinated as well as uncoordinated deployment (for example femto cell deployment) where the macro NW does not know all the parameters sent by the femto cell. Embodiments may not require tight management of the network; since such embodiments are based upon UE measurement, the NW operator does not need to update parameters such as CPICH TX power for every pico cell deployed. In embodiments, if a pico cell updates its CPICH TX power from time-to-time (for example to control its coverage/interference), then the UE is able to take the new CPICH TX power into account when performing cell reselection evaluation.

The additional information employed by the UE for implementing embodiments, can be obtained in various ways.

In embodiments, weighting factor X is broadcast by the current cell as a single parameter applicable for all the neighbour cells, or a subset of the cells. In embodiments, weighting factor X is broadcast as a different value in the neighbour cell list for different individual cells or groups of cells. In embodiments, weighting factor X is calculated using a combination of information from the current cell and reading from the neighbour cell system information (for example weighting factor X may vary dependent on the size of the cell or according to different deployment reasons such as coverage extension, capacity offloading or suchlike).

In embodiments, the pathloss is calculated by the UE by reading the CPICH Tx power from the neighbour cell and using the measured power from the neighbour cell. In embodiments, the pathloss is broadcast by the current cell for each neighbour cell (requiring tighter co-ordination in the NW). In embodiments, a default value of CPICH Tx power is used for some cells, for example macro cells, or cells for which information has not yet been read.

Embodiment provide the network operator with the capability to control the balance between whether known (DL-based) reselection criteria are used, or whether UL-based criteria (such as pathloss) are used by using a weighting factor X. In embodiments, weighting factor X is tuned by the operator between a value of 0 and 1 depending on how much the operator wants UL-based criteria (such as pathloss) to be taken into account in cell reselections. As weighting factor X moves towards a value of 1, the effect of the DL measurements becomes less.

It is known that to minimize UL interference it is best for a UE to connect to the serving cell with smallest pathloss on the frequency and it is also known that from a DL point of view, the strongest cell on a carrier frequency will give the best signal-noise ratio. In a heterogeneous environment, these two cells are not necessarily the same cell, but, in general (although not necessarily), the UE can only be connected to one cell. Embodiments therefore introduce the weighting factor X to define the extent to which UL-based criteria (such as pathloss) influence the outcome.

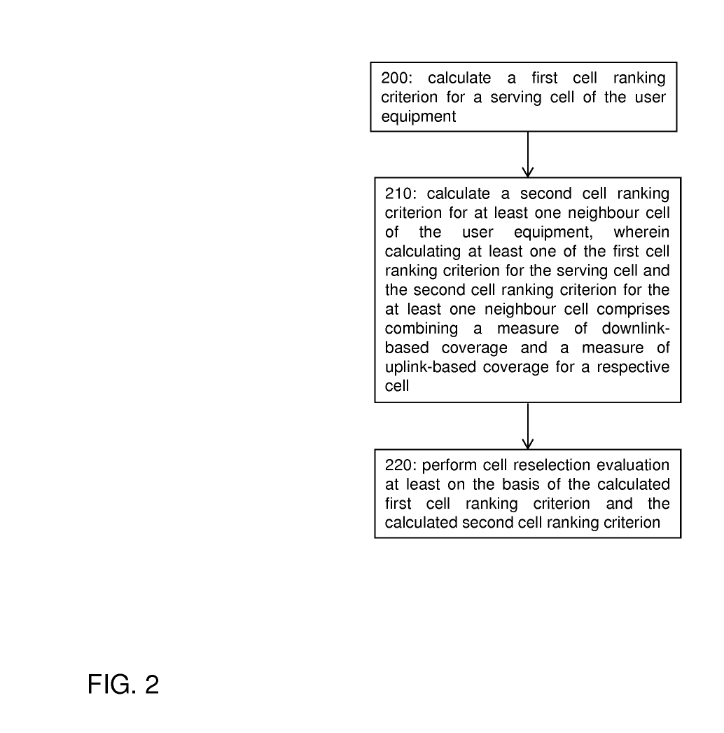

FIG. 2 shows a flow diagram according to first embodiments. In particular, FIG. 2 depicts measures for use in controlling radio resource usage in a cellular telecommunications network from the perspective of a UE such as UE 50 (or a part thereof, for example a modem).

Item 200 comprises calculating a first cell ranking criterion for a serving cell of the user equipment.

Item 210 comprises calculating a second cell ranking criterion for at least one neighbour cell of the user equipment, wherein calculating at least one of the first cell ranking criterion for the serving cell and the second cell ranking criterion for the at least one neighbour cell comprises combining a measure of downlink-based coverage and a measure of uplink-based coverage for a respective cell.

Item 220 comprises performing cell reselection evaluation at least on the basis of the calculated first cell ranking criterion and the calculated second cell ranking criterion.

In second embodiments, a network-based approach is employed. In these embodiments, the NW determines how to set the existing cell reselection parameters to trigger cell reselection at the same point as would be expected with the UE based-approach of first embodiments described above, accounting for the different CPICH TX power of the nodes. In the second embodiments, the NW uses a measure of UL-based coverage, for example pathloss, for the serving cell and/or one or more known neighbour cells in the process of calculating modified cell reselection parameters which are then broadcast by the serving/current cell.

Embodiments comprise measures, including methods, apparatus, and computer program products, for use in cell reselection in a cellular telecommunications network.

A network entity (such as an RNC, serving cell 80 or pico cell 110) (or ‘network element’ or ‘network node’ or ‘network control entity’, etc.) calculates one or more modified cell reselection parameters of at least one of a first cell ranking criterion for a serving cell of a user equipment (such as UE 50) and a second cell ranking criterion for at least one neighbour cell of the user equipment. The network entity calculates the one or more modified cell reselection parameters at least on the basis of a measure of uplink-based coverage for a respective cell. The network entity transmits the one or modified more cell reselection parameters to the user equipment.

In embodiments, the calculation of the one or more modified cell reselection parameters is carried out by the network node further on the basis of a measure of downlink-based coverage for a respective cell.

According to embodiments, the calculating comprises the network entity controlling the extent to which the measure of uplink-based coverage for a respective cell affects the calculation of the one or more modified cell reselection parameters.

In embodiments, the measure of uplink-based coverage comprises a pathloss metric for a respective cell, for example based at least in part on received signal code power (RSCP).

In embodiments, the controlling carried out by the network entity comprises applying a weighting factor (herein denoted weighting factor ‘X’) to one or more existing downlink-based coverage cell reselection parameters from one or more of the first cell ranking criterion and the second cell ranking criterion to produce the one or more modified cell reselection parameters. The weighting factor controls the extent to which the measure of uplink-based coverage for a respective cell affects the calculation. The weighting factor may for example comprise a value between zero and 1.

In embodiments, the applying carried out by the network entity comprises multiplying the reciprocal of the weighting factor added to 1 by the one or more existing downlink-based coverage cell reselection parameters.

In embodiments, the applying carried out by the network entity comprises multiplying the reciprocal of the weighting factor added to 1 by the one or more existing downlink-based coverage cell reselection parameters to produce a first value, dividing the weighting factor by the weighting factor added to 1 and multiplying the result of the division by a power of a pilot channel signal transmitted by a respective cell to produce a second value, and adding the first value to the second value to produce the one or more modified cell reselection parameters.

The following equations define the serving cell and neighbour cell ranking with new weighting X factor added according to embodiments:

Rs=Qmeas,s+Qhyst,s+Qoffmbms−X*PL,s

Rn=Qmeas,n−Qoffsets,n+Qoffmbms−TOn*(1−Ln)−X*PL,n

If an assumption is made that received signal code power (RSCP) is employed for cell reselection purposes, then the pathloss=CPICH TX power−Qmeas, which means that the serving cell and neighbour cell ranking equations become:

Rs=Qmeas,s+Qhyst,s+Qoffmbms−X(CPICHTX,s−Qmeas,s)

Rn=Qmeas,n−Qoffsets,n+Qoffmbms−TOn*(1−Ln)−X(CPICHTX,n−Qmeas,n)

The above equations can be rearranged to the following:

Rs=(1+X)Qmeas,s+Qhysts−XCPICHTX,s+Qoffmbms

Rn=(1+X)Qmeas,n−Qoffsets,n−XCPICHTX,n+Qoffmbms−TOn*(1−Ln)

The condition Rn>Rs triggers cell reselection, in which case the following inequality applies:

(1+X)Qmeas,n−Qoffsets,n−XCPICHTX,n+Qoffmbms−TOn*(1−Ln)(1+X)>(1+X)Qmeas,s+Qhysts−XCPICHTX,s+Qoffmbms

If both sides of the above inequality are divided by 1+X, the following inequality is produced:

Qmeas,n−(1/(1+X)Qoffset_{s,n}−(X/(1+X))CPICHTX,n+(1/(1+X))Qoffmbms−(1/(1+X))TOₙ*(1−Lₙ)>Qmeas,s+(1/(1+X))Qhysts+(X/(1+X))CPICHTX,s+(1/(1+X))Qoffmbms

Since CPICHTX,n is a constant, the same effect could be obtained by reparameterising the existing reselection equation with the following modified cell reselection parameters:

Qoffset′s,n=1/(1+X)Qoffset_{s,n}+X/(1+X)CPICHTX,n

Qhyst,s′=(1/(1+X))Qhyst,s+(X/(1+X))CPICHTX,s

Qoffmbms′=(1/(1+X))Qoffmbms

Temp_Offset,n′=(1/(1+X))Temp_Offset,n

In embodiments, the one or more modified cell reselection parameters comprise one or more of:

a hysteresis value from the first cell ranking criterion (i.e. Qhyst,s′),

a first offset value from the first cell ranking criterion in the case of the serving cell belonging to a multimedia broadcast and multicast service preferred layer (MBMS PL) and/or from the second cell ranking criterion in the case of the at least one neighbour cell belonging to a multimedia broadcast and multicast service preferred layer (MBMS PL) (i.e. Qoffmbms′),

a second offset value from the second cell ranking criterion calculated relative to the serving cell (i.e. Qoffset′s,n), and

a temporal offset from the second cell ranking criterion in the case of a hierarchical cell structure (HCS) being indicated in system information for the at least one neighbour cell (i.e. Temp_Offset,n′).

In embodiments, the cellular telecommunications network comprises a heterogeneous network in which one of the serving call and the at least one neighbour cell comprises a relatively high power node and another of the serving call and the at least one neighbour cell comprises a relatively low power node with uplink and/or downlink coverage at least partially overlapping with the macro cell. The relatively high power node may for example comprise a macro cell and the relatively low power node may for example comprise a micro, pico or femto cell. In embodiments, the relatively high power node uses at least one carrier frequency which is the same as at least one carrier frequency of the relatively low power node.

In embodiments, the transmittal of the one or more modified cell reselection parameters to the user equipment is carried out via one or more of the serving cell and the at least one neighbour cell.

According to embodiments, the network entity first calculates one or more first modified cell reselection parameters of a first cell ranking criterion for a serving cell of a user equipment. The first calculation of the one or more first modified cell reselection parameters is carried out at least on the basis of a measure of uplink-based coverage for the serving cell. The network entity second calculates one or more second modified cell reselection parameters of a second cell ranking criterion for at least one neighbour cell of the user equipment. The second calculation of the one or more second modified cell reselection parameters is carried out at least on the basis of a measure of uplink-based coverage for the at least one neighbour cell. The network entity transmits the one or more first modified cell reselection parameters and the one or more second modified cell reselection parameters to the user equipment.

In embodiments, the network entity transmits the one or modified more cell reselection parameters to one or more further user equipment other than UE 50. In some embodiments, the NW broadcasts modified cell reselection parameters to all UEs, including also legacy UEs. In other embodiments, the NW only transmits modified cell reselection parameters to non-legacy UEs.

The term ‘legacy UE’ here refers to a UE which does not support the enhanced functionality of embodiments for calculating modified cell reselection parameters according to first embodiments described above, but which is capable of triggering cell reselection on the basis of modified cell reselection parameters which they receive from the NW according to second embodiments described above. In the latter case, the UE is not aware that the cell reselection parameters it receives from the network have been modified by the NW to take uplink-based coverage into account.

Taking the above information into account, which may be carried out via operations and management in the network or via communication between RNCs, the RNC is able to update the information for its neighbouring cells.

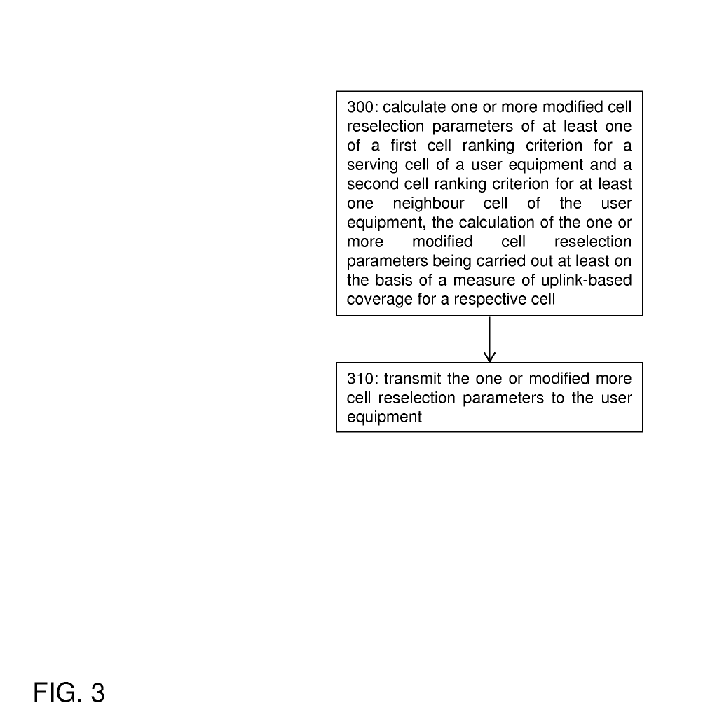

FIG. 3 shows a flow diagram according to second embodiments. In particular, FIG. 3 depicts measures for use in controlling radio resource usage in a cellular telecommunications network from the perspective of a network entity (or a part thereof) such as an RNC, serving cell or neighbour cell.

Item 300 comprises the network entity calculating one or more modified cell reselection parameters of at least one of a first cell ranking criterion for a serving cell of a user equipment and a second cell ranking criterion for at least one neighbour cell of the user equipment, the calculation of the one or more modified cell reselection parameters being carried out at least on the basis of a measure of uplink-based coverage for a respective cell.

Item 310 comprises the network entity transmitting the one or modified more cell reselection parameters to the user equipment.

Due to the fact that embodiments take uplink coverage into account, cell size is accounted for when choosing the best cell for a UE to camp on; embodiments therefore help to avoid interference scenarios.

Embodiments allow the cell reselection process to be tuned by the NW in some cases so that legacy UE interference can be reduced or avoided.

Cell ranking calculations and cell reselection evaluation can be carried out by the UE for use in some un-coordinated deployments and/or cases where it has not been possible to fully tune the NW broadcast parameters.

The UE-based approach described above is especially suitable if pico nodes change their CPICH TX power setting from time to time, for example as part of a self organising network (SON) procedure to optimize interference mitigation.

FIGS. 2 and 3 represent results from executing a computer program or an implementing algorithm stored in the local memory of UE 50 or a network entity (such as an RNC (not shown), serving cell 80 or neighbour cell 110) respectively as well as illustrating the operation of a method and a specific manner in which the processing system and/or processor and memory with computer program/algorithm are configured to cause UE 50 or the network entity respectively (or one or more components thereof) to operate. The various blocks shown in these Figures may also be considered as a plurality of coupled logic circuit elements constructed to carry out the associated function(s), or specific result or function of strings of computer program code stored in a computer readable memory. Such blocks and the functions they represent are non-limiting examples, and may be practiced in various components such as integrated circuit chips and modules, and that embodiments of the present invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with embodiments of the present invention.

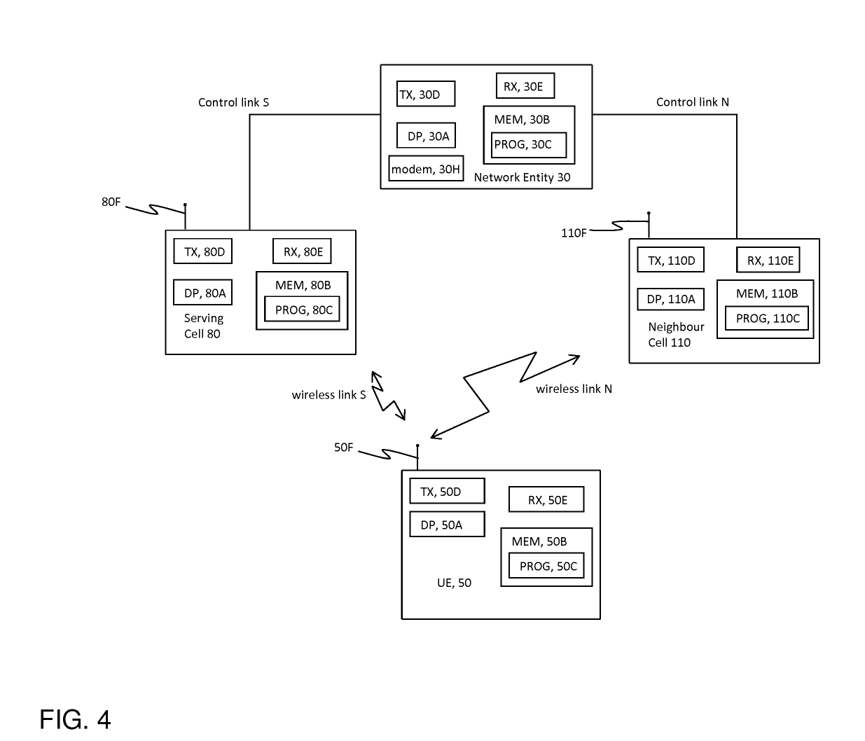

Reference is now made to FIG. 4 for illustrating a simplified block diagram of various electronic devices and apparatus that are suitable for use in practicing embodiments of the present invention. In FIG. 4, serving cell 80 is adapted for communication over a wireless link S with a UE 50, such as a mobile terminal. Similarly, a neighbour cell 110 is adapted for communication over a wireless link N with UE 50. Serving cell 80 and/or neighbour cell 110 each may comprise a macro Node B, an eNodeB, a remote radio head, relay station, a femto cell or home NodeB, or other type of base station/cellular network access node.

UE 50 may include processing means such as a processing system and/or at least one data processor (DP) 50A, storing means such as at least one computer-readable memory (MEM) 50B storing at least one computer program (PROG) 50C, and also communicating means such as a transmitter TX 50D and a receiver RX 50E for bidirectional wireless communications with the serving cell 80 and/or neighbour cell 110 and/or any other neighbouring cells (not shown) via one or more antennas 50F. Note that embodiments may be carried out by apparatus such as a modem which does not comprise an antenna.

Serving cell 80 includes its own processing means such as a processing system and/or at least one data processor (DP) 80A, storing means such as at least one computer-readable memory (MEM) 80B storing at least one computer program (PROG) 80C, and communicating means such as a transmitter TX 80D and a receiver RX 80E for bidirectional wireless communications with other devices under its control via one or more antennas 80F. There is a data and/or control path, termed at FIG. 4 as a control link S which in the 3GPP cellular system may be implemented as an Iub interface or in E-UTRAN as an S1 interface, coupling the serving cell 80 with network entity 30, and over which the network entity 30 and the serving cell 80 may exchange control messages, such as system information update requests and/or change notifications. Network entity 30 may for example comprise an RNC, MME or suchlike.

Similarly, neighbour cell 110 includes its own processing means such as a processing system and/or at least one data processor (DP) 110A, storing means such as at least one computer-readable memory (MEM) 110B storing at least one computer program (PROG) 110C, and communicating means such as a transmitter TX 110D and a receiver RX 110E for bidirectional wireless communications with other devices under its control via one or more antennas 110F. There is a data and/or control path, termed at FIG. 4 as a control link N which in the 3GPP cellular system may be implemented as an Iub interface or in E-UTRAN as an S1 interface, coupling the neighbour cell 110 with network entity 30, and over which network entity 30 and the neighbour cell 110 may exchange control messages, such as system information update requests and/or change notifications.

Network entity 30 includes processing means such as a processing system and/or at least one data processor (DP) 30A, storing means such as at least one computer-readable memory (MEM) 30B storing at least one computer program (PROG) 30C, and communicating means such as a modem 30H for bidirectional communication with serving cell 80 over control link S or with neighbour cell 110 over control link N.

While not particularly illustrated for UE 50, serving cell 80, neighbour cell 110 and network entity 30, those devices are also assumed to include as part of their wireless communicating means a modem which may be inbuilt on a RF front end chip within those devices 50, 80, 110 30 and which chip also carries the TX 50D/80D/110D/30D and the RX 50E/80E/110E/30E.

Various embodiments of UE 50 can include, but are not limited to: cellular telephones (or ‘mobile’ telephones) including so-called smartphones; data cards, USB dongles, laptop computers, personal portable digital devices having wireless communication capabilities including but not limited to laptop/palmtop/tablet computers, digital cameras and music devices, and Internet appliances.

At least one of the PROGs 50C in UE 50 is assumed to include program instructions that, when executed by the associated DP 50A, enable the device to operate in accordance with embodiments of the present invention, as detailed above. Serving cell 80, neighbour cell 110 and network entity 30 also have software stored in their respective MEMs to implement certain aspects of these teachings. In these regards, embodiments of this invention may be implemented at least in part by computer software stored on the MEM 50B, 80B, 110B, 30B which is executable by the DP 50A of UE 50, DP 80A of serving cell 80, DP 110A of neighbour cell 110 and/or DP 30A of network entity 30, or by hardware, or by a combination of tangibly stored software and hardware (and tangibly stored firmware). Electronic devices implementing these aspects of the invention need not be the entire devices as depicted at FIG. 4, but embodiments may be implemented by one or more components of same such as the above described tangibly stored software, hardware, firmware and DP, or a system on a chip SOC, an application specific integrated circuit ASIC or a digital signal processor DSP.

Various embodiments of the computer readable MEMs 50B, 80B, 110B and 30B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 50A, 30A, 110A and 80A include but are not limited to general purpose computers, special purpose computers, microprocessors, digital signal processors (DSPs) and multi-core processors.

The above embodiments are to be understood as illustrative examples of the invention. Further embodiments of the invention are envisaged.

The term embodiment herein should be taken to mean an example and the term embodiments herein should be taken to mean some examples, such that description of an embodiment or embodiments refers to some embodiments, but not necessarily all embodiments.

Alternative embodiments comprise using one weighting factor X for weighting the UL-based coverage measure and a different weighting factor, say weighting factor Y (i.e. not 1−X) for weighting the DL-based coverage measure. Weighting of the UL-based coverage measure and the DL-based coverage measure can therefore be carried out independently of each other.

Embodiments described above relate to UE-based or NW-based approached. In alternative embodiments, a combination of UE-based and NW-based approaches can be employed. For example, a NW-based approach could be employed in areas where it is beneficial to update parameters also for legacy devices, whereas a UE-based approach could be employed in other cases. As one example, femto cell default parameters could allow fast deployment of pico cells by using a default factor weighting factor X. As another example, a NW-based approach could apply a default value for parameters such as weighting factor X, thus allowing UEs which support the enhanced functionality of embodiments to further enhance the calculations using parameters broadcast by a neighbour cell or suchlike.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

### LIST OF ACRONYMS AND ABBREVIATIONS

3GPP 3rd generation partnership project
CPICH common pilot channel
CSG closed subscriber group
DL downlink
EUTRAN evolved universal mobile telecommunications system radio access network
eNB evolved Node B
HCS hierarchical cell structure
HS-DPCCH high speed dedicated physical control channel
HSPA high-speed packet access
HSUPA high-speed uplink packet access
IE information element
LTE long term evolution
LTE-A long term evolution advanced
MBMS PL multimedia broadcast-multicast service preferred layer
MME mobility management entity
NW network
P-GW packet data network gateway
Rel-12 3GPP release 12
RNC radio network controller
RSCP received signal code power
RX receiver
S-GW serving gateway
SON self organising network
TS technical specification
TTI transmission timing interval
TVM traffic volume measurement
TX transmitter
UE user equipment
UL uplink
UMTS universal mobile telecommunications service
WCDMA wideband code division multiple access

1. Apparatus for use in cell reselection in a cellular telecommunications network, said apparatus comprising a processing system adapted to, at a user equipment:
calculate a first cell ranking criterion for a serving cell of said user equipment;
calculate a second cell ranking criterion for at least one neighbour cell of said user equipment, wherein calculating at least one of said first cell ranking criterion for said serving cell and said second cell ranking criterion for said at least one neighbour cell comprises combining a measure of downlink-based coverage and a measure of uplink-based coverage for a respective cell; and
perform cell reselection evaluation at least on the basis of said calculated first cell ranking criterion and said calculated second cell ranking criterion.

2. Apparatus according to claim 1, wherein said combining comprises adding said measure of downlink-based coverage to said measure of uplink-based coverage.

3. Apparatus according to claim 1, wherein said combining comprises controlling the extent to which said measure of uplink-based coverage for a respective cell affects said cell reselection evaluation.

4. Apparatus according to claim 3, wherein said controlling comprises multiplying said measure of uplink-based coverage for a respective cell by a weighting factor to produce a first product and said combining comprises adding said first product to said measure of downlink-based coverage.

5. Apparatus according to claim 3, wherein said controlling comprises multiplying said measure of uplink-based coverage for a respective cell by a weighting factor to produce a first product and multiplying said measure of downlink-based coverage for a respective cell by said weighting factor subtracted from 1 to produce a second product and said combining comprises adding said first product to said second product.

6. Apparatus according to claim 4, wherein said weighting factor comprises a value between zero and 1.

7. Apparatus according to claim 4, said processing system being adapted to receive said weighting factor from said serving cell.

8. Apparatus according to claim 7, said processing system being adapted to:
read first system information from said at least one neighbour cell; and
adjust said received weighting factor on the basis of said read first system information.

9. Apparatus according to claim 1, said processing system being adapted to read second system information from one or more of said serving cell and said at least one neighbour cell,
wherein said performed cell reselection evaluation is carried out further on the basis of said read second system information.

10. Apparatus according to claim 1, said processing system being adapted to receive from one or more of said serving cell and said at least one neighbour cell an indication of measured uplink interference for a respective cell,
wherein said performed cell reselection evaluation is carried out further on the basis of said received indication.

11. Apparatus according to claim 1, wherein said measure of uplink-based coverage comprises a pathloss metric for a respective cell.

12-26. (canceled)

27. A method for use in cell reselection in a cellular telecommunications network, said method comprising, at a user equipment:
calculating a first cell ranking criterion for a serving cell of said user equipment;
calculating a second cell ranking criterion for at least one neighbour cell of said user equipment, wherein calculating at least one of said first cell ranking criterion for said serving cell and said second cell ranking criterion for said at least one neighbour cell comprises combining a measure of downlink-based coverage and a measure of uplink-based coverage for a respective cell; and
performing cell reselection evaluation at least on the basis of said calculated first cell ranking criterion and said calculated second cell ranking criterion.

28. (canceled)

29. Apparatus for use in cell reselection in a cellular telecommunications network, said apparatus comprising a processing system adapted to, at a network entity:
calculate one or more modified cell reselection parameters of at least one of a first cell ranking criterion for a serving cell of a user equipment and a second cell ranking criterion for at least one neighbour cell of said user equipment, said calculation of said one or more modified cell reselection parameters being carried out at least on the basis of a measure of uplink-based coverage for a respective cell; and
causing transmittal of said one or modified more cell reselection parameters to said user equipment.

30. Apparatus according to claim 29, wherein said calculation of said one or more modified cell reselection parameters is carried out further on the basis of a measure of downlink-based coverage for a respective cell.

31. Apparatus according to claim 29, wherein said calculating comprising controlling the extent to which said measure of uplink-based coverage for a respective cell affects said calculation of said one or more modified cell reselection parameters.

32. Apparatus according to claim 31, wherein said controlling comprises applying a weighting factor to one or more existing downlink-based coverage cell reselection parameters from one or more of said first cell ranking criterion and said second cell ranking criterion to produce said one or more modified cell reselection parameters, said weighting factor controlling the extent to which said measure of uplink-based coverage for a respective cell affects said calculation.

33. Apparatus according to claim 31, wherein said weighting factor comprises a value between zero and 1.

34. Apparatus according to claim 32, wherein said applying comprises multiplying the reciprocal of said weighting factor added to 1 by said one or more existing downlink-based coverage cell reselection parameters.

35. Apparatus according to claim 32, wherein said applying comprises:
multiplying the reciprocal of said weighting factor added to 1 by said one or more existing downlink-based coverage cell reselection parameters to produce a first value;
dividing said weighting factor by said weighting factor added to 1 and multiplying the result of said division by a power of a pilot channel signal transmitted by a respective cell to produce a second value; and
adding said first value to said second value to produce said one or more modified cell reselection parameters.

36. Apparatus according to claim 29, wherein said one or more modified cell reselection parameters comprise one or more of:
a hysteresis value from said first cell ranking criterion,
a first offset value from said first cell ranking criterion in the case of said serving cell belonging to a multimedia broadcast and multicast service preferred layer (MBMS PL) and/or from said second cell ranking criterion in the case of said at least one neighbour cell belonging to a multimedia broadcast and multicast service preferred layer (MBMS PL),
a second offset value from said second cell ranking criterion calculated relative to the serving cell, and
a temporal offset from said second cell ranking criterion in the case of a hierarchical cell structure (HCS) being indicated in system information for the at least one neighbour cell.

37.-50. (canceled)
